(19) United States
(12) Patent Application Publication
(10) Pub. No.: US 2020/0117217 A1
(43) Pub. Date: Apr. 16, 2020

(54) DELIVERY SYSTEM AND METHOD, AND DELIVERY PROCESSING DEVICE

(71) Applicant: HONDA MOTOR CO., LTD., MINATO-KU, TOKYO (JP)

(72) Inventors: Makoto YUZAWA, WAKO-SHI, SAITAMA-KEN (JP); Seiichi YAMAMOTO, MINATO-KU, TOKYO (JP); Atsushi NISHI, WAKO-SHI, SAITAMA-KEN (JP); Takaichi SANO, WAKO-SHI, SAITAMA-KEN (JP); Miyuki SHIMOTA, WAKO-SHI, SAITAMA-KEN (JP); Keiichi IGUCHI, MINATO-KU, TOKYO (JP)

(21) Appl. No.: 16/621,575

(22) PCT Filed: Jun. 13, 2017
(86) PCT No.: PCT/JP2017/021819

§ 371 Date: Dec. 11, 2019

(51) Int. Cl. G05D 1/10; G05D 1/02; B60W 60/00; B64C 39/02; G06Q 10/08

(52) U.S. Cl. CPC G05D 1/101; G05D 1/0212; B64C 2201/128; B64C 39/024; G06Q 10/0833; B60W 60/00256

(57) ABSTRACT

The present invention pertains to a delivery system and delivery method, and a delivery processing device. A delivery processing means, provided with: a delivery destination designation unit for designating a first mobile body as a delivery destination for an item; and a mobile body information provision unit for providing, to a second mobile body, travel plan information or identification information of the designated first mobile body. The second mobile body autonomously travels on the basis of the travel plan information or the identification information from a delivery processing means.

### TECHNICAL FIELD

The present invention relates to a delivery system, a delivery method, and a delivery processing apparatus (device) for delivering an item using a mobile body.

### BACKGROUND ART

Recently, various services using mobile bodies that can drive autonomously have been proposed. A specific example is a support service that provides an autonomous driving vehicle for travelling sales to an owner of a mobile shop who does not have a fixed shop.

Japanese Laid-Open Patent Publication No. 2015-069594 proposes an apparatus and method for automatically generating a travel schedule of the mobile shop based on various types of information concerning user demand, events, and roads in a region. In this way, the ability to optimize a sales route corresponding to seasons and a product is disclosed.

### SUMMARY OF INVENTION

However, in the method proposed in Japanese Laid-Open Patent Publication No. 2015-069594, the user must be in a designated place at a designated time after confirming the travel schedule. In particular, there is a problem that it is difficult to flexibly change an item pick-up location when this method is applied to a delivery service, and this is not convenient for the user.

The present invention has been devised in order to solve this type of problem, and has the object of providing a delivery system, delivery method, and delivery processing apparatus offering flexibility for item pick-up locations and greatly improving the convenience of a service.

A delivery system according to a first aspect of the present invention comprises a delivery processing means that receives a delivery request for an item from a first mobile body or an occupant of the first mobile body, or judges whether delivery of the item to the first mobile body is necessary; and a second mobile body that is configured to be capable of delivering the item to the first mobile body while moving autonomously, in response to delivery instructions from the delivery processing means, wherein the delivery processing means includes a delivery destination designating unit that designates the first mobile body as a delivery destination of the item; and a mobile body information providing unit that provides the second mobile body with identification information or movement plan information of the first mobile body designated by the delivery destination designating unit, and the second mobile body moves autonomously based on the identification information or the movement plan information provided by the mobile body information providing unit.

In this way, the first mobile body is designated as the delivery destination of the item and the identification information or the movement plan information of the first mobile body is transmitted to the second mobile body, and therefore, under the assumption that the first mobile body moves after receiving the delivery request, the second mobile body can autonomously move with the first mobile body itself (i.e. a moving object instead of a stationary object) as a target. In this way, there is flexibility with regard to the location where the item is picked up, and the convenience of the service is significantly improved.

The first mobile body may be a vehicle that travels on land, the second mobile body may be a vehicle that travels on land or a flying body that flies through the air, and the second mobile body may approach the first mobile body when the first mobile body has stopped or when movement velocity of the first mobile body has become less than or equal to a prescribed velocity.

The first mobile body may be provided with at least one opening portion capable of opening and closing, and the second mobile body may move in a manner to follow the first mobile body, while being near the opening portion of the first mobile body.

A roof portion and a side surface portion of the first mobile body may each be provided with an opening portion, and the second mobile body may be a flying body and may select an approach direction and/or a position of the opening portion according to at least one of content of the item, traffic conditions of a road, and weather conditions. By considering how the burden on the occupant or the degree of difficulty of the pick-up changes according to the content of the item, the traffic conditions of the roads, or the weather conditions, it is possible to perform a pick-up operation suitable for the situation.

The delivery system may further comprise a mobile body selecting means that selects either a vehicle or a flying body as the second mobile body, according to at least one of content of the item, traffic conditions of a road, and weather conditions. By considering how the degree of difficulty of the delivery changes according to the content of the item, the traffic conditions of the roads, or the weather conditions, it is possible to use a type of mobile body suitable for the situation.

The delivery system may further comprise a stock storage facility that stores stock items of a product, wherein the first mobile body may be a mobile shop capable of housing the product, and the second mobile body may deliver the stock item that is inside the stock storage facility, as the item.

The delivery processing means may further include a stock information acquiring unit that acquires stock information of the product in the mobile shop; and a delivery necessity judging unit that judges that delivery of the stock item to the mobile shop is necessary if the stock information acquired by the stock information acquiring unit satisfies a prescribed condition.

The second mobile body may acquire the stock item from the stock storage facility for which a distance to the mobile shop is predicted to be less than or equal to a prescribed value, based on the movement plan information provided by the mobile body information providing unit. In this way, after the stock item in the stock storage facility has been acquired, the second mobile body can quickly deliver the stock item to the mobile shop while the mobile shop is moving at a position near this stock storage facility.

A delivery method according to a second aspect of the present invention includes using a delivery system that comprises a delivery processing means that receives a delivery request for an item from a first mobile body or an occupant of the first mobile body, or judges whether delivery of the item to the first mobile body is necessary; and a second mobile body that is configured to be capable of delivering the item to the first mobile body while moving autonomously, in response to delivery instructions from the delivery processing means, wherein the delivery processing means performs a designating step of designating the first mobile body as a delivery destination of the item; and a providing step of providing the second mobile body with identification information or movement plan information of the designated first mobile body, and the second mobile body moves autonomously based on the identification information or the movement plan information provided by the delivery processing means.

A delivery processing means according to a third aspect of the present invention comprises a delivery destination designating unit that receives a delivery request for an item from a first mobile body or an occupant of the first mobile body, or, if delivery of the item to the first mobile body is necessary, designates the first mobile body as a delivery destination of the item; and a mobile body information providing unit that provides a second mobile body, which is configured to be capable of delivering the item through autonomous movement, with identification information or movement plan information of the first mobile body designated by the delivery destination designating unit.

The delivery system and method, and the delivery processing apparatus according to the present invention are flexible in connection with the item pick-up locations, making it possible to offer services that are more convenient.

### BRIEF DESCRIPTION OF DRAWINGS

FIG. 1 shows an overall configuration of the delivery system according to the first embodiment;

FIG. 2 shows an operation sequence in the delivery system of FIG. 1;

FIG. 3 is a first descriptive diagram concerning a delivery mobile body selection method and a planned delivery location determination method;

FIG. 4 is a second descriptive diagram concerning a delivery mobile body selection method and a planned delivery location determination method;

FIG. 5 is a third descriptive diagram concerning a delivery mobile body selection method and a planned delivery location determination method;

FIG. 6 is a fourth descriptive diagram concerning a delivery mobile body selection method and a planned delivery location determination method;

FIGS. 7A and 7B are schematic views of behavior change of the delivery mobile body;

FIGS. 8A and 8B are schematic views of states in which the occupant of the customer vehicle picks up the item;

FIG. 9 is a planar view of a joined state between the customer vehicle and the delivery vehicle;

FIG. 10 shows an overall configuration of the delivery system according to the second embodiment of the present invention;

FIG. 11 shows an operation sequence in the delivery system of FIG. 10; and

FIG. 12 shows an overall configuration of the delivery system according to a modification of the first embodiment.

### DESCRIPTION OF EMBODIMENTS

The following provides examples of preferred embodiments relating to a delivery method and a delivery processing apparatus in a delivery system according to the present invention, while referencing the accompanying drawings.

### First Embodiment

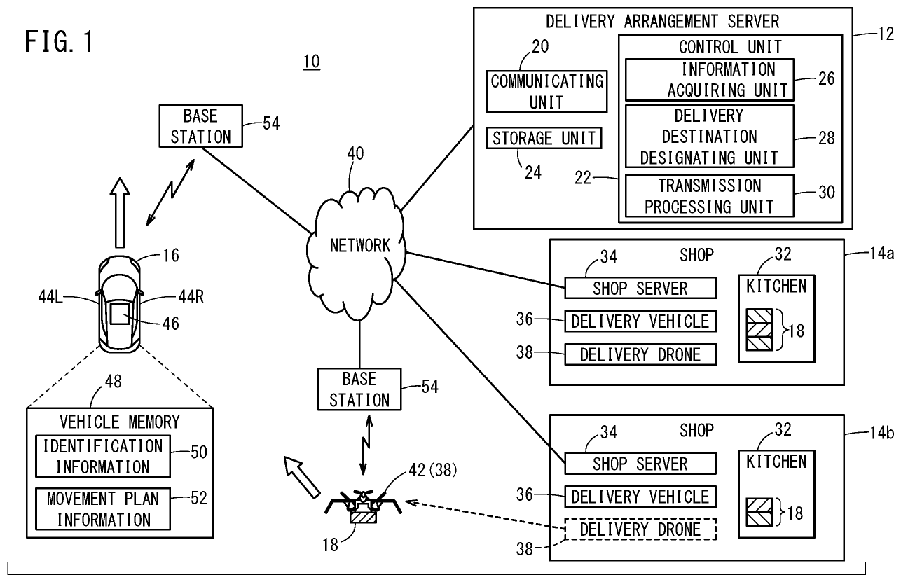

First, a delivery system 10 according to a first embodiment of the present invention will be described while referencing FIGS. 1 to 8.

### <Overall Configuration of the Delivery System 10>

FIG. 1 shows an overall configuration of the delivery system 10 according to the first embodiment. The delivery system 10 is a system applied to a restaurant franchise, for example. This delivery system 10 is basically formed by a delivery arrangement server 12 (delivery processing means and delivery processing apparatus) and various apparatuses provided in one or more shops (the two shops 14a, 14b in the example of the present drawing).

The delivery arrangement server 12 receives a delivery request of a product 18 (item) from a customer vehicle 16 (first mobile body) or an occupant in the customer vehicle 16, and arranges delivery of the product 18 to a specified shop (e.g. the shop 14b).

The delivery arrangement server 12 is configured to include a communicating unit 20, a control unit 22, and a storage unit 24. The communicating unit 20 is formed from a communication module that transmits and receives electrical signals to and from an external apparatus. The control unit 22 is formed from a process computing apparatus including a CPU (Central Processing Unit) and an MPU (Micro-Processing Unit). The control unit 22 functions as an information acquiring unit 26, a delivery destination designating unit 28, and a transmission processing unit 30 (mobile body information providing unit) by reading and executing programs stored in the storage unit 24.

The storage unit 24 is non-transitory, and is formed from a computer readable storage medium. Here, the computer readable storage medium is a storage device such as a magneto-optical disk, ROM, or CD-ROM, a portable medium such as a flash memory, a hard disk built into a computer system, or the like.

Each of the shops 14a, 14b is provided with a kitchen 32, a shop server 34 (mobile body selecting means), one or more delivery vehicles 36, and one or more delivery drones 38. In the kitchen 32, the product 18 such as hamburgers, pizza, or sushi is produced in response to orders from within the shop or outside the shop. The shop server 34 is a computer having a hardware configuration equivalent to that of the delivery arrangement server 12, and is connected in a bi-directionally communicable manner to the delivery arrangement server 12 via a network 40.

The delivery vehicle 36 is a vehicle configured to be able to travel autonomously on land, and is capable of housing the product 18. The delivery drone 38 is a flying body configured to be able to fly autonomously through the air, and is capable of grasping the product 18. Below, there are cases where the delivery vehicle 36 or the delivery drone 38 that delivers the product 18 to the customer vehicle 16 while moving autonomously according to delivery instructions from the delivery arrangement server 12 is referred to as a delivery mobile body 42 (second mobile body).

The customer vehicle 16 is a vehicle that is able to travel via manual driving or automated driving, and is capable of housing occupants who are customers. An opening portion 44R that can open and close is provided in a right-side surface portion of the customer vehicle 16, and an opening portion 44L that can open and close is provided in a left-side surface portion of the customer vehicle 16. Furthermore, an opening portion 46 that can open and close is provided in a roof portion of the customer vehicle 16.

Identification information 50 and movement plan information 52 are stored in a vehicle memory 48 incorporated in the customer vehicle 16. The identification information 50 is information capable of specifying any vehicle, and may be a VIN (Vehicle Identification Number), for example. The movement plan information 52 is information indicating a movement plan of the customer vehicle 16, and may be a planned travel route (including a destination) or the position of this vehicle in real time. Below, there are cases where the identification information 50 or the movement plan information 52 is referred to collectively as “delivery destination information”.

The customer vehicle 16, the delivery vehicle 36, and the delivery drone 38 are each capable of accessing the network 40, via the closest base station 54. Here, the base station 54 is a base that relays wide-area wireless communication such as 4G, 5G, and LTE (Long Term Evolution) or narrow-area wireless communication such as Wi-Fi and DSRC (Dedicated Short Range Communications).

### <Operation of the Delivery System 10>

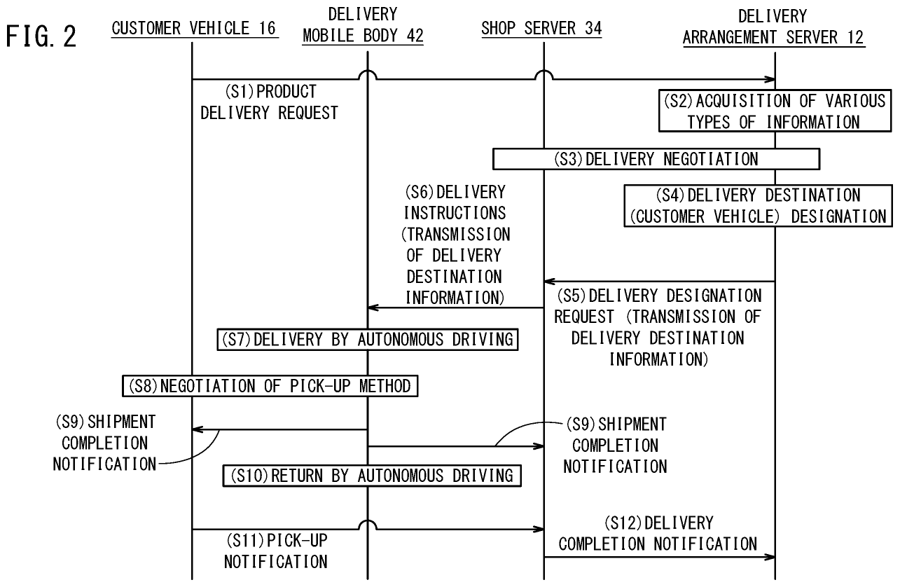

FIG. 2 shows an operation sequence in the delivery system 10 of FIG. 1. The customer vehicle 16, the delivery mobile body 42, the shop server 34, and the delivery arrangement server 12 are involved in this operation sequence, in the stated order from the left.

At step S1, the customer vehicle 16 makes a delivery request for the product 18 in response to an ordering operation by an occupant (a manipulation of an in-vehicle device). Specifically, the customer vehicle 16 transmits, to the delivery arrangement server 12, a request signal including various types of information such as order information input by the occupant and delivery destination information read from the vehicle memory 48. Instead of the customer vehicle 16, the delivery request to the delivery arrangement server 12 may be made from a portable terminal (e.g. a smartphone) possessed by the occupant.

At step S2, the communicating unit 20 of the delivery arrangement server 12 receives the request signal transmitted from the customer vehicle 16 at step S1. Then, the information acquiring unit 26 acquires the various types of information (e.g. the order information and the delivery destination information) included in the received request signal.

At step S3, the delivery arrangement server 12 performs a negotiation concerning the delivery with the shop server 34 that is a delivery request candidate, based on the various types of information acquired at step S2. Here, it is envisioned that the delivery drone 38 associated with the shop 14b is able to be used.

At step S4, if the negotiation of step S3 has ended and it has been confirmed that delivery is possible, the delivery destination designating unit 28 of the delivery arrangement server 12 designates the customer vehicle 16 as the delivery destination of the product 18.

At step S5, the transmission processing unit 30 of the delivery arrangement server 12 makes a delivery instruction request to the shop 14b that has received the delivery request. Specifically, the transmission processing unit 30 transmits a request signal including the order information and the delivery destination information to the shop server 34 in the shop 14b.

At step S6, the shop server 34 issues delivery instructions for the product 18 to the delivery mobile body 42, which is in a usable state in the shop 14b. Specifically, the shop server 34 transmits an instruction signal including delivery destination information to the delivery drone 38 in the shop 14b.

At step S7, after the loading of the product 18 has been completed, the delivery mobile body 42 performs autonomous movement based on the delivery destination information transmitted at step S6. The delivery mobile body 42 then reaches a location in the vicinity of the customer vehicle 16.

At step S8, the delivery mobile body 42 performs a negotiation with the customer vehicle 16 concerning the pick-up method for the product 18. As a result, the occupant of the customer vehicle 16 can pick up the product 18 from the delivery mobile body 42.

At step S9, the delivery mobile body 42 provides notification that the shipment has been completed (shipment completion notification) to each of the customer vehicle 16 and the shop server 34. After this, the delivery mobile body 42 returns to the shop 14b through autonomous movement (step S10).

At step S11, the customer vehicle 16 provides notification that the product 18 has been picked up (pick-up notification) to the shop server 34. At step S12, the shop server 34 provides notification that the delivery of the product 18 has been completed (delivery completion information) to the delivery arrangement server 12.

### <Specific Example of the Negotiation (Step S3)>

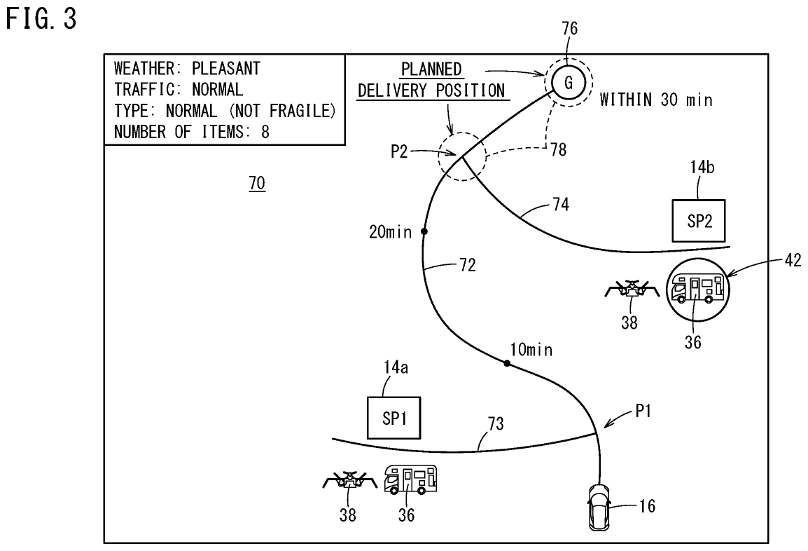

The following describes in detail the negotiation between the delivery arrangement server 12 and the shop server 34 occurring at step S3 of FIG. 2 in a specific example of the operation of the delivery system 10, while referencing FIGS. 3 to 6.

For the negotiation of step S3, the delivery arrangement server 12 or the shop server 34 may select either the delivery vehicle 36 or the delivery drone 38 as the delivery mobile body 42, according to at least one of the content of the product 18, the traffic conditions of the roads, and the weather conditions. By considering how the degree of difficulty of the delivery changes according to the content of the item 18, the traffic conditions of the roads, or the weather conditions, it is possible to use a type of mobile body (delivery mobile body 42) suitable for the situation.

Examples of the content of the product 18 include size, weight, number of items, durability, value, and environmental resistance. If the product 18 has [1] a large size, [2] a heavy weight, [3] a large number of items, [4] low durability, or [5] a high value, the delivery vehicle 36 that has a relatively low delivery risk is preferably selected.

Examples of the traffic conditions of the roads include the degree of traffic congestion, road level difference, road curviness, and road width. If the nearby roads have [1] a large amount of traffic, [2] large level differences, [3] high road curviness, or [4] narrow road width, the delivery drone 38 capable of moving through the air is preferably selected.

Examples of the weather conditions include the weather, temperature, humidity, amount of sunlight, rainfall, and wind speed. If the nearby roads are experiencing [1] bad weather, [2] a temperature outside a certain range, [3] a humidity outside a certain range, [4] a large amount of sunlight, [5] a large amount of rainfall, or [6] strong winds, it is more preferable to select the delivery vehicle 36 that has a relatively high ability to protect the product 18.

### (Delivery Scheme Determination)

As shown in FIGS. 3 to 6, three roads (travel road 72 and branch roads 73 and 74) are provided in a nearby area 70 of the customer vehicle 16. The branch road 73 is a road that branches to the left from a branch point P1 (close to the customer vehicle 16) of the travel road 72. The branch road 74 is a road the branches to the right from a branch point P2 (far from the customer vehicle 16) of the travel road 72.

The shop 14a (referred to below as the shop “SP1”) of FIG. 1 is arranged facing the branch road 73, and the shop 14b (referred to below as the shop “SP2”) of FIG. 1 is arranged facing the branch road 74. Each of the shops “SP1” and “SP2” has one delivery vehicle 36 and one delivery drone 38 deployed.

Here, the customer vehicle 16 travels toward a destination 76 while progressing straight along the travel road 72. The position of the customer vehicle 16 shown in the present drawing corresponds to the current position at the timing when the delivery request for the product 18 is made (referred to below as the delivery request timing). The filled-in circle marks shown in the travel road 72 indicate the predicted positions of the customer vehicle 16 at 10-minute intervals. In the example of FIG. 3, the customer vehicle 16 has a plan to arrive at the destination 76 within 30 minutes from the delivery request timing.

For each of the situations shown FIGS. 3 to 6, a scheme (i.e. a delivery scheme) is determined for realizing the delivery of the product 18 within a limited time (e.g. within 30 minutes from the delivery request timing) and without interfering with the travelling of the customer vehicle 16.

In the example shown in FIG. 3, the weather is “pleasant”, the traffic condition is “normal”, the type of item 18 is “normal (not fragile)”, and the number of items 18 is “8”. In this case, in consideration of the number (8) of items 18, the delivery vehicle 36 that has a relatively large maximum storage space is selected instead of the delivery drone 38 that has a relatively low maximum storage space. Furthermore, in consideration of the traffic condition being “normal”, it is judged that the delivery vehicle 36 cannot overtake the customer vehicle 16 if the delivery vehicle 36 leaves from the shop “SP1”.

As a result, the delivery arrangement server 12 or the shop server 34 selects the delivery vehicle 36 assigned to the shop “SP2” as the delivery mobile body 42. Furthermore, the delivery arrangement server 12 or the shop server 34 selects the destination 76 or a position near the branch point P2 as the position where the delivery of the product 18 is planned (referred to below as the planned delivery position 78).

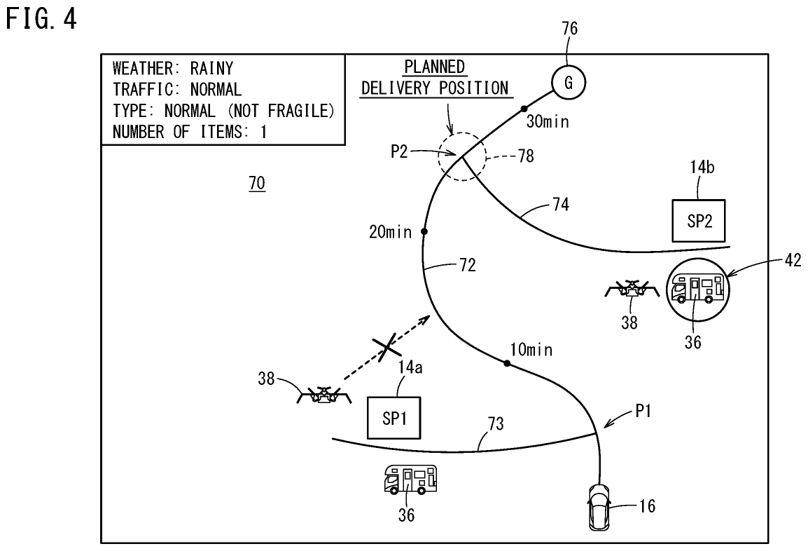

In the example shown in FIG. 4, the weather is “rainy”, the traffic condition is “normal”, the type of item 18 is “normal (not fragile)”, and the number of items 18 is “1”. As an example, if an attempt is being made to minimize the delivery time, it is preferable to select the delivery drone 38 of the shop “SP1”. Furthermore, in consideration of the weather being “rainy”, the delivery vehicle 36 that has a relatively high ability to protect the product 18 is selected instead of the delivery drone 38 that has a relatively low ability to protect the product 18.

As a result, the delivery arrangement server 12 or the shop server 34 selects the delivery vehicle 36 assigned to the shop “SP2” as the delivery mobile body 42. Furthermore, in consideration of the customer vehicle 16 not arriving at the destination 76 within the limited time due to the rain, the delivery arrangement server 12 or the shop server 34 selects only the position near the branch point P2 as the planned delivery position 78.

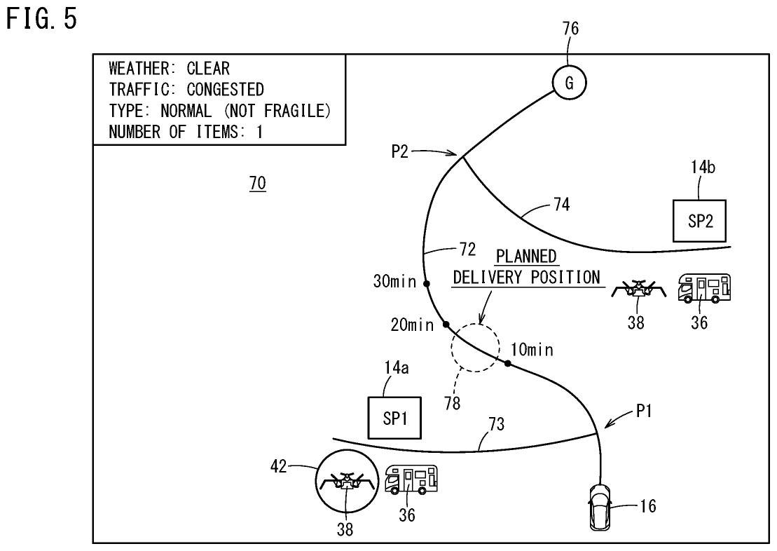

In the example shown in FIG. 5, the weather is “clear”, the traffic condition is “congested”, the type of item 18 is “normal (not fragile)”, and the number of items 18 is “1”. In this case, in consideration of the traffic condition being “congested”, the delivery drone 38 that has relatively high mobility is selected instead of the delivery vehicle 36 that has relatively low mobility. Furthermore, in consideration of the prediction result that the customer vehicle 16 will reach a position near a midway point between the branch points P1 and P2 when 30 minutes have passed, it is judged that the position of the customer vehicle 16 cannot be reached if the delivery drone 38 leaves from the shop “SP2”.

As a result, the delivery arrangement server 12 or the shop server 34 selects the delivery drone 38 assigned to the shop “SP1” as the delivery mobile body 42. Furthermore, the delivery arrangement server 12 or the shop server 34 selects a prescribed position beyond the branch point P1 (a position roughly predicted to be 15 minutes away), as the planned delivery position 78.

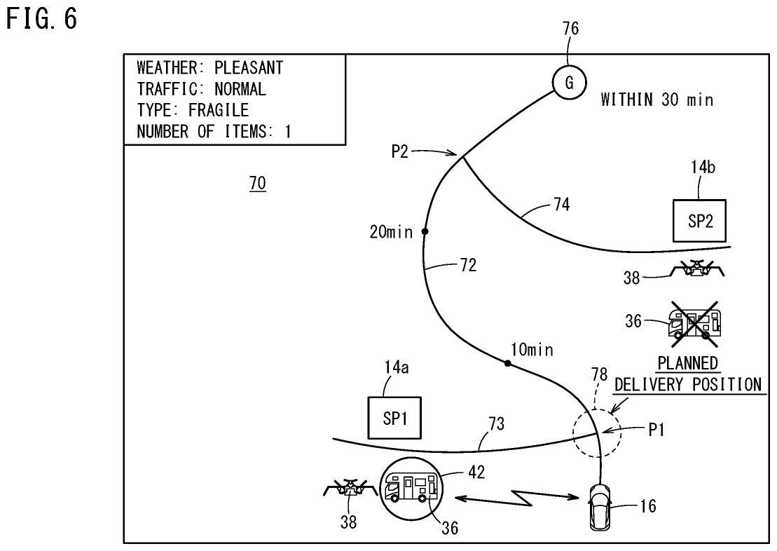

In the example shown in FIG. 6, the weather is “pleasant”, the traffic condition is “normal”, the type of item 18 is “fragile”, and the number of items 18 is “1”. In this case, in consideration of the type of item 18 being “fragile”, the delivery vehicle 36 that has a relatively low delivery risk is selected instead of the delivery drone 38 that has a relatively high delivery risk. Furthermore, it is judged that the delivery vehicle 36 assigned to the shop “SP2” is currently in operation, and cannot make the delivery within the limited time if this delivery vehicle 36 returns to the shop “SP2” and then leaves again.

As a result, the delivery arrangement server 12 or the shop server 34 selects the delivery vehicle 36 assigned to the shop “SP1” as the delivery mobile body 42. Furthermore, the delivery arrangement server 12 or the shop server 34 selects a position near the branch point P1 as the planned delivery position 78. In this case, it should be noted that the delivery arrangement server 12 or the delivery mobile body 42 performs a further negotiation with the customer vehicle 16 concerning the planned delivery position 78.

### <Specific Example of the Negotiation (Step S8)>

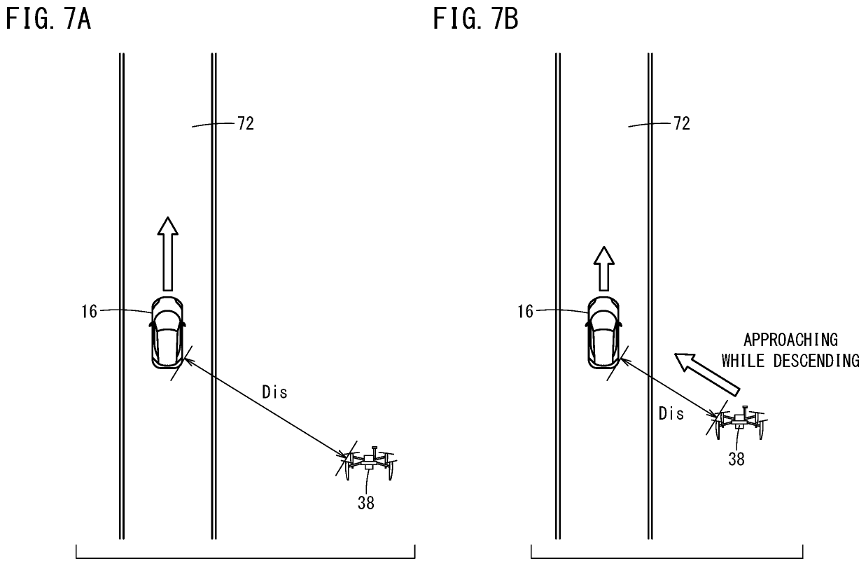

The following describes in detail the negotiation between the customer vehicle 16 and the delivery mobile body 42 occurring at step S8 of FIG. 2 in a specific example of the operation of the delivery system 10, while referencing FIGS. 7A to 9.

### (Example Case of the Delivery Drone 38)

When the customer vehicle 16 has stopped or the movement velocity of the customer vehicle 16 has become less than or equal to a prescribed velocity, the delivery drone 38 may approach the customer vehicle 16. By sufficiently lowering the movement velocity of the customer vehicle 16, the product 18 can be picked up easily.

As shown in FIG. 7A, while the customer vehicle 16 is travelling on the travel road 72 at a movement velocity that exceeds a predetermined threshold value (e.g. 10 km/h, which corresponds to a low velocity), the delivery drone 38 waits at a position in the air distanced from the customer vehicle 16 by a distance Dis.

As shown in FIG. 7B, when the movement velocity of the customer vehicle 16 has become less than or equal to the threshold value described above, the delivery drone 38 approaches the customer vehicle 16 while descending toward the travel road 72. Therefore, the distance Dis between the customer vehicle 16 and the delivery drone 38 gradually decreases.

After this, in a case where the roof portion and side surface portions of the customer vehicle 16 are respectively provided with the opening portions 44R (L) and 46, the delivery drone 38 may select an approach direction and/or position of the opening portion 44R (L) or 46 according to at least one of the content of the product 18, the traffic conditions on the road, and the weather conditions. By considering the change in the burden on the occupant or the difficulty of the pick-up according to the content of the product 18, the traffic conditions on the road, or the weather conditions, it is possible to perform a pick-up operation suitable for the situation.

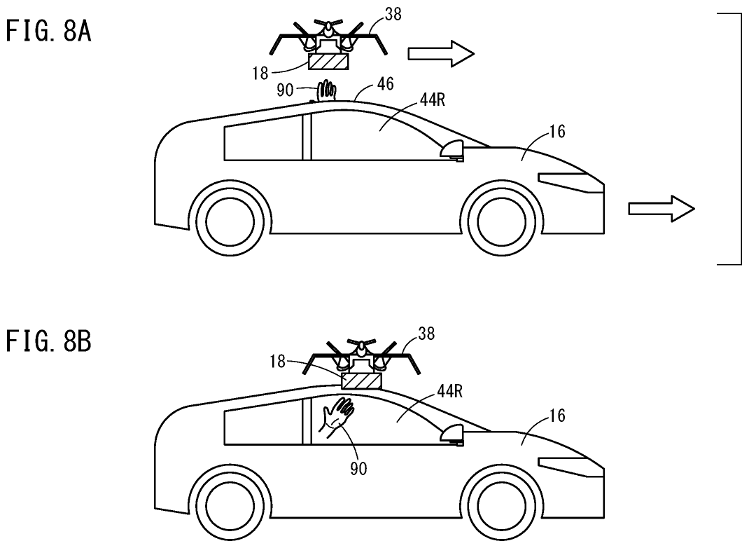

As an example, as shown in FIG. 8A, the delivery drone 38 may move in a manner to follow the customer vehicle 16 from above the customer vehicle 16, while being near the opening portion 46 of the roof portion. In this way, the occupant of the customer vehicle 16 can pick up the product 18 by extending a hand 90 upward.

Furthermore, as shown in FIG. 8B, the delivery drone 38 may move in a manner to follow the customer vehicle 16 from the right side, with the progression direction of the customer vehicle 16 as a reference, while being near the opening portion 44R of the right-side portion. In this way, the occupant of the customer vehicle 16 can pick up the product 18 by extending a hand 90 to the right.

### (Example Case of the Delivery Vehicle 36)

When the customer vehicle 16 has stopped or the movement velocity of the customer vehicle 16 has become less than or equal to a prescribed velocity, the delivery vehicle 36 may approach the customer vehicle 16. In the same manner as with the delivery drone 38, by sufficiently lowering the movement velocity of the customer vehicle 16, the product 18 can be picked up easily.

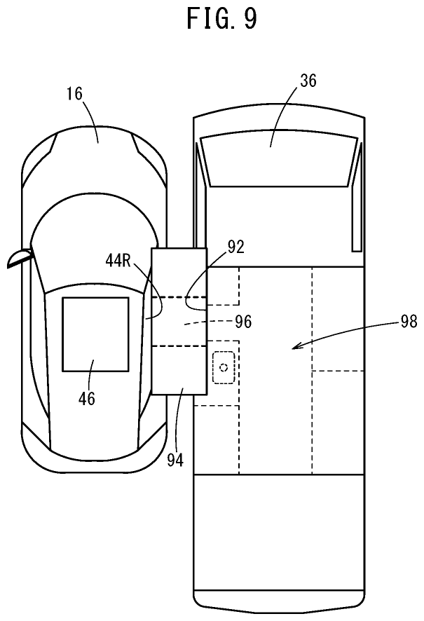

As shown in FIG. 9, the customer vehicle 16 and the delivery vehicle 36 may be joined by providing a connecting and fixing portion 94 that is shaped as an angular hollow tube at a location covering the opening portion 44R of the customer vehicle 16 and an opening portion 92 of the delivery vehicle 36. This joining operation may be performed while the customer vehicle 16 and the delivery vehicle 36 are in a stopped state, or may be performed while the customer vehicle 16 and the delivery vehicle 36 are travelling in parallel.

Here, by setting the opening portion 44R and the opening portion 92 to an open state, the occupant of the customer vehicle 16 can enter into an indoor space 98 of the delivery vehicle 36 through a communication space 96 formed by the connecting and fixing portion 94. In this way, the occupant can cook and enjoy meals using the cooking facilities provided in the indoor space 98.

### Effects Realized by the First Embodiment

As described above, the delivery system 10 includes [1] the delivery arrangement server 12 (delivery processing means) that receives the delivery request for the product 18 (item) from the customer vehicle 16 (first mobile body) or the occupant of the customer vehicle 16 and [2] the delivery mobile body 42 (second mobile body) that is configured to be capable of delivering the product 18 to the customer vehicle 16 while moving autonomously, in response to delivery instructions from the delivery arrangement server 12.

The delivery arrangement server 12 (delivery processing apparatus) includes [3] the delivery destination designating unit 28 that designates the customer vehicle 16 as the delivery destination of the product 18 and [4] the transmission processing unit 30 (mobile body information providing unit) that provides the delivery mobile body 42 with the identification information 50 or the movement plan information 52 of the designated customer vehicle 16, and [5] the delivery mobile body 42 performs autonomous movement based on the identification information 50 or the movement plan information 52 provided by the transmission processing unit 30.

Furthermore, in the delivery method using the delivery system 10, the delivery arrangement server 12 performs [3] a designating step (S4) of designating the customer vehicle 16 as the delivery destination of the product 18 and [4] a providing step (S5, S6) of providing the delivery mobile body 42 with the identification information 50 or the movement plan information 52 of the designated customer vehicle 16, and [5] the delivery mobile body 42 performs autonomous movement based on the identification information 50 or the movement plan information 52 provided by the delivery arrangement server 12 (S7).

In this way, the customer vehicle 16 is designated as the delivery destination of the product 18 and the identification information 50 or the movement plan information 52 is transmitted to the delivery mobile body 42, and therefore, under the assumption that the customer vehicle 16 moves after receiving the delivery request, the delivery mobile body 42 can autonomously move with the customer vehicle 16 itself (i.e. a moving object instead of a stationary object) as a target. In this way, there is flexibility with regard to the location where the product 18 is picked up, and the convenience of the service is significantly improved.

### Second Embodiment

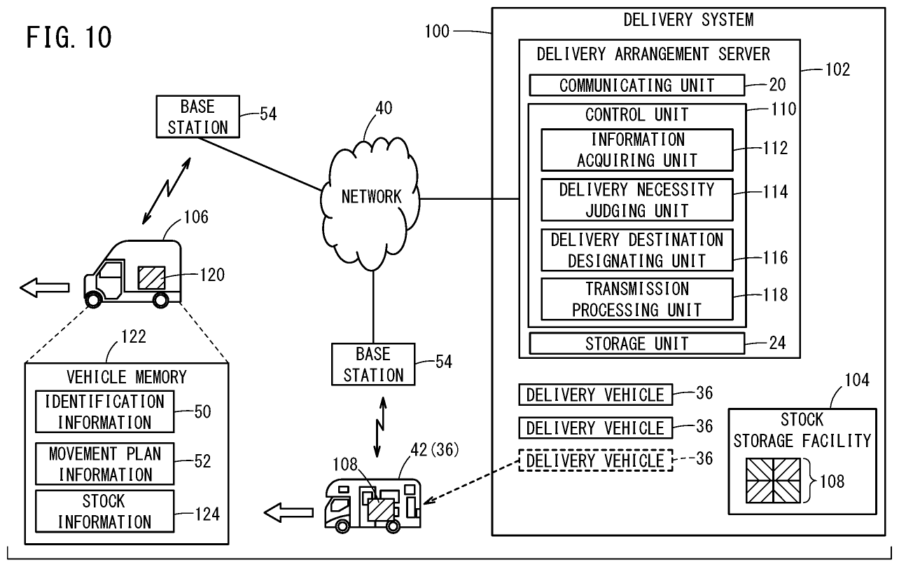

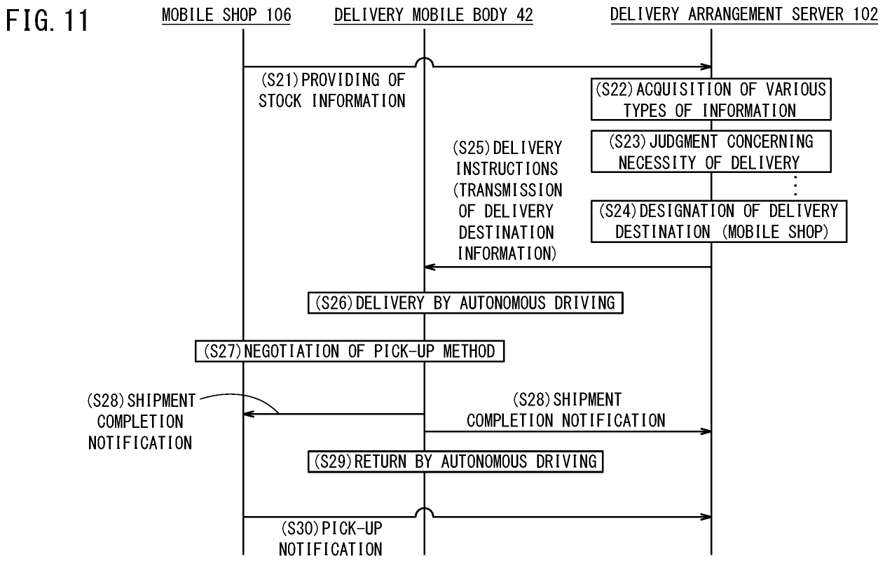

The following describes a delivery system 100 according to a second embodiment of the present invention, while referencing FIGS. 10 and 11. Descriptions of configurational elements that are the same as those in the first embodiment are sometimes omitted.

### <Overall Configuration of the Delivery System 100>

FIG. 10 shows an overall configuration of the delivery system 100 according to the second embodiment of the present invention. The delivery system 100 is a system applied to a mobile shop network of clothing shops, for example. The delivery system 100 is basically formed from a delivery arrangement server 102 (delivery processing means and delivery processing apparatus), a stock storage facility 104, and one or more delivery vehicles 36 (three in the example of the present drawing).

The delivery arrangement server 102 judges whether delivery of a stock item 108 (item) to each mobile shop 106 is necessary, and arranges the delivery of the stock item 108 to the specified mobile shop 106.

The delivery arrangement server 102 is configured to include the communicating unit 20, a control unit 110, and the storage unit 24. The control unit 110 is formed from a process computing apparatus including a CPU and an MPU. The control unit 110 functions as an information acquiring unit 112 (stock information acquiring unit), a delivery necessity judging unit 114, a delivery destination designating unit 116, and a transmission processing unit 118 (mobile body information providing unit) by reading and executing programs stored in the storage unit 24.

The stock storage facility 104 is a facility that stores a stock of the product 120. A sufficient number of stock items 108 are always stocked in the stock storage facility 104, in a manner to be able to respond to these items selling out in many mobile shops 106 or stationary shops (not shown in the drawings).

The mobile shop 106 is a vehicle that is capable of housing the products 120 that are items to be sold and of travelling via manual driving or automated driving. Stock information 124, in addition to the identification information 50 and the movement plan information 52, is stored in a vehicle memory 122 incorporated in the mobile shop 106. The stock information 124 is information indicating the stocked state of the mobile shop 106, and the newest information may be acquired using a POS (Point Of Sales) system or IC data.

The mobile shop 106 and the delivery vehicle 36 are each capable of accessing the network 40 via the closest base station 54. In other words, the delivery arrangement server 102, the mobile shop 106, and the delivery vehicle 36 are all configured to be capable of bi-directional communication.

### <Operation of the Delivery System 100>

FIG. 11 shows an operation sequence in the delivery system 100 of FIG. 10. The mobile shop 106, the delivery mobile body 42, and the delivery arrangement server 102 are involved in this operation sequence, in the stated order from the left.

At step S21, the mobile shop 106 regularly or irregularly reads the newest stock information from the vehicle memory 122 and provides this stock information to the delivery arrangement server 102. Specifically, the mobile shop 106 transmits, to the delivery arrangement server 102, a request signal including the stock information 124 and the delivery destination information read from the vehicle memory 122.

At step S22, the communicating unit 20 of the delivery arrangement server 102 receives the request signal transmitted from the mobile shop 106 at step S21. The information acquiring unit 112 then acquires various types of information (e.g. the stock information 124 and the delivery destination information) included in the received request signal.

At step S23, the delivery necessity judging unit 114 of the delivery arrangement server 102 judges whether the stock information 124 acquired at step S22 satisfies a prescribed condition. Specifically, the delivery necessity judging unit 114 judges that delivery of the stock item 108 is unnecessary if the number of products 120 in stock is greater than or equal to a threshold value, and determines that delivery of the stock item 108 is necessary if the number of products 120 in stock is less than the threshold value. Here, it is envisioned that delivery to the mobile shop 106 is necessary.

At step S24, the delivery destination designating unit 116 of the delivery arrangement server 102 designates the mobile shop 106 as the delivery destination of the stock item 108.

At step S25, the delivery arrangement server 102 issues delivery instructions for the stock item 108 to the delivery mobile body 42, which is in a usable state within a site of the delivery system 100. Specifically, the delivery arrangement server 102 transmits an instruction signal including the delivery destination information to the delivery vehicle 36, which is in a site of the delivery system 100.

Here, the delivery mobile body 42 may acquire the stock item 108 from the stock storage facility 104 for which the distance to the mobile shop 106 is predicted to be less than or equal to a prescribed value based on the movement plan information 52 provided by the delivery arrangement server 102 (transmission processing unit 118). In this way, after the stock item 108 in the stock storage facility 104 has been acquired, the delivery mobile body 42 can quickly deliver the stock item 108 to the mobile shop 106 while the mobile shop 106 is moving at a position near this stock storage facility 104.

Furthermore, the delivery mobile body 42 may complete the acquisition of the stock item 108 in the stock storage facility 104 in accordance with a timing (nearby timing) at which the distance from the mobile shop 106 is predicted to be less than or equal to a prescribed value. In this way, it is possible to shorten the delivery lead time from when the stock item 108 is acquired to when the delivery is completed, and to make the delivery as efficiently as possible.

At step S26, after the loading of the stock item 108 has been completed, the delivery mobile body 42 performs autonomous movement based on the delivery destination information transmitted at step S25. After this, the delivery mobile body 42 arrives at a position near the mobile shop 106.

At step S27, the delivery mobile body 42 performs a negotiation with the mobile shop 106 concerning the pick-up method for the stock item 108. As a result, the occupant of the mobile shop 106 can pick up the stock item 108 from the delivery mobile body 42.

At step S28, the delivery mobile body 42 provides notification that the shipment has been completed (shipment completion information) to each of the mobile shop 106 and the delivery arrangement server 102. The delivery mobile body 42 returns to the site of the delivery system 100 by autonomous movement (step S29). Finally, the mobile shop 106 provides notification that the stock item 108 has been delivered (delivery completion information) to the delivery arrangement server 102 (step S30).

### Effects Realized by the Second Embodiment

As described above, the delivery system 100 includes [1] the delivery arrangement server 102 (delivery processing means) that judges whether the delivery of the stock item 108 (item) to the mobile shop 106 (first mobile body) is necessary, [2] the delivery mobile body 42 (second mobile body) that is configured to be capable of delivering the stock item 108 to the mobile shop 106 while moving autonomously, in response to delivery instructions from the delivery arrangement server 102, and [3] the stock storage facility 104 that stores the stock of the product 120.

The delivery arrangement server 102 (delivery processing apparatus) includes [4] the delivery destination designating unit 116 that designates the mobile shop 106 as the delivery destination of the stock item 108 and [5] the transmission processing unit 118 (mobile body information providing unit) that provides the delivery mobile body 42 with the identification information 50 or the movement plan information 52 of the designated mobile shop 106, and [6] the delivery mobile body 42 moves autonomously based on the identification information 50 or the movement plan information 52 provided by the delivery arrangement server 102.

Furthermore, in the delivery method using the delivery system 100, the delivery arrangement server 102 performs [4] the designating step (S24) of designating the mobile shop 106 as the delivery destination of the stock item 108 and [5] the providing step (S25) of providing the delivery mobile body 42 with the identification information 50 of the movement plan information 52 of the designated mobile shop 106, and [6] the delivery mobile body 42 moves autonomously based on the identification information 50 or the movement plan information 52 provided by the delivery arrangement server 102 (S26).

In this way, the mobile shop 106 is designated as the delivery destination of the stock item 108 and the identification information 50 or the movement plan information 52 is transmitted to the delivery mobile body 42, and therefore, under the assumption that the mobile shop 106 moves after receiving the delivery request, the delivery mobile body 42 can autonomously move with the mobile shop 106 itself (i.e. a moving object instead of a stationary object) as a target. In this way, there is flexibility with regard to the location where the stock item 108 is picked up, and the convenience of the service is significantly improved.

### Modifications

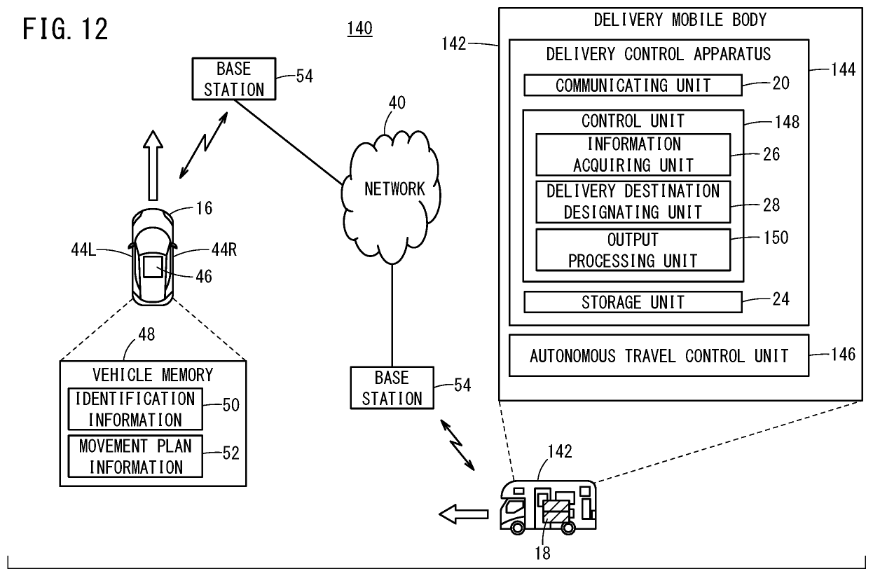

The following describes a modification to the first embodiment (FIGS. 1 to 9), while referencing FIG. 12. This modification can be applied to the second embodiment (FIGS. 10 and 11) as well.

FIG. 12 shows an overall configuration of a delivery system 140 according to the modification of the first embodiment. The delivery system 140 is basically formed from one or more delivery mobile bodies 142 (the delivery vehicles in the example of the present drawing).

After the delivery request for the product 18 has been directly received from the customer vehicle 16 or the occupant of the customer vehicle 16, the delivery mobile body 142 delivers the product 18 to the customer vehicle 16. Specifically, the delivery mobile body 142 is formed to include a delivery control apparatus 144 (delivery processing means and delivery processing apparatus) and an autonomous travel control unit 146.

The delivery control apparatus 144 is configured to include, in addition to the communicating unit 20 and the storage unit 24, a control unit 148 that has a different function than the control unit 22 (FIG. 1). This control unit 148 functions as the information acquiring unit 26, the delivery destination designating unit 28, and an output processing unit 150 (mobile body information providing unit) by reading and executing programs stored in the storage unit 24.

The output processing unit 150 outputs a request signal including the order information and the delivery destination information (the identification information 50 or the movement plan information 52). The autonomous travel control unit 146 creates a movement plan for the delivery mobile body 142, based on the identification information 50 or the movement plan information 52 output from the output processing unit 150, and performs movement control in accordance with this movement plan.

In this way, the delivery mobile body 142 may be responsible for at least some of the functions that can be realized by the delivery arrangement server 12 (FIG. 1). With this configuration of the delivery system 140 as well, it is possible to realize the same effects as in the first embodiment of realizing flexibility for the pick-up location of the product 18 and significantly improving the convenience of the service.

### [Supplement]

The present invention is not limited to the above-described embodiment, and it goes without saying that various modifications could be adopted therein without departing from the essence and gist of the present invention. Alternatively, any of these configurations may be combined, as long as the combination does not result in a technical contradiction.

1. A delivery system comprising:
a delivery processing unit configured to receive a delivery request for an item from a first mobile body or an occupant of the first mobile body, or judge whether delivery of the item to the first mobile body is necessary; and
a second mobile body that is configured to be capable of delivering the item to the first mobile body while moving autonomously, in response to delivery instructions from the delivery processing unit, wherein
the delivery processing unit includes:
a delivery destination designating unit configured to designate the first mobile body as a delivery destination of the item; and
a mobile body information providing unit configured to provide the second mobile body with identification information or movement plan information of the first mobile body designated by the delivery destination designating unit,
the second mobile body moves autonomously based on the identification information or the movement plan information provided by the mobile body information providing unit,
the first mobile body is a vehicle that travels on land,
the second mobile body is a vehicle that travels on land or a flying body that flies through the air, and
the second mobile body approaches the first mobile body when the first mobile body has stopped or when movement velocity of the first mobile body has become less than or equal to a prescribed velocity.

2. (canceled)

3. The delivery system according to claim 1, wherein
the first mobile body is provided with at least one opening portion capable of opening and closing, and
the second mobile body moves in a manner to follow the first mobile body, while being near the opening portion of the first mobile body.

4. The delivery system according to claim 1, wherein
a roof portion and a side surface portion of the first mobile body are each provided with an opening portion, and
the second mobile body is a flying body and selects an approach direction and/or a position of the opening portion according to at least one of content of the item, traffic conditions of a road, and weather conditions.

5. The delivery system according to claim 1, further comprising:
a mobile body selecting unit configured to select either a vehicle or a flying body as the second mobile body, according to at least one of content of the item, traffic conditions of a road, and weather conditions.

6. The delivery system according to claim 1, further comprising:
a stock storage facility that stores stock items of a product, wherein
the first mobile body is a mobile shop capable of housing the product, and
the second mobile body delivers the stock item that is inside the stock storage facility, as the item.

7. The delivery system according to claim 6, wherein
the delivery processing unit further includes:
a stock information acquiring unit configured to acquire stock information of the product in the mobile shop; and
a delivery necessity judging unit configured to judge that delivery of the stock item to the mobile shop is necessary if the stock information acquired by the stock information acquiring unit satisfies a prescribed condition.

8. The delivery system according to claim 6, wherein
the second mobile body acquires the stock item from the stock storage facility for which a distance to the mobile shop is predicted to be less than or equal to a prescribed value, based on the movement plan information provided by the mobile body information providing unit.

9. A delivery method using a delivery system that comprises:
a delivery processing unit configured to receive a delivery request for an item from a first mobile body or an occupant of the first mobile body, or judge whether delivery of the item to the first mobile body is necessary; and
a second mobile body that is configured to be capable of delivering the item to the first mobile body while moving autonomously, in response to delivery instructions from the delivery processing unit, wherein
the delivery processing unit configured to perform:
a designating step of designating the first mobile body as a delivery destination of the item; and
a providing step of providing the second mobile body with identification information or movement plan information of the designated first mobile body,
the second mobile body moves autonomously based on the identification information or the movement plan information provided by the delivery processing unit,
the first mobile body is a vehicle that travels on land,
the second mobile body is a vehicle that travels on land or a flying body that flies through the air, and the second mobile body approaches the first mobile body when the first mobile body has stopped or when movement velocity of the first mobile body has become less than or equal to a prescribed velocity.

10. A delivery processing apparatus comprising:
a stock information acquiring unit configured to acquire stock information of a product in a first mobile body as a mobile shop;
a delivery necessity judging unit configured to judge whether the stock information acquired by the stock information acquiring unit satisfies a prescribed condition,
a delivery destination designating unit configured to, if the delivery necessity judging unit judges that delivery of the item to the mobile shop is necessary, designate the mobile shop as a delivery destination of the item; and
a mobile body information providing unit configured to provide a second mobile body, which is configured to be capable of delivering the item through autonomous movement, with identification information or movement plan information of the mobile shop designated by the delivery destination designating unit.
